(19) United States
(12) Patent Application Publication
(10) Pub. No.: US 2003/0084456 A1
(43) Pub. Date: May 1, 2003

(54) Mixed entertainment application

(76) Inventors: Timothy L. Ryan, McKinney, TX (US); Anna Antoszkiewicz, Little Elm, TX (US)

Correspondence Address: TEXAS INSTRUMENTS INCORPORATED, P O BOX 655474, M/S 3999, DALLAS, TX, 75265

(21) Appl. No.: 10/262,471

(22) Filed: Sep. 30, 2002

Related U.S. Application Data
(60) Provisional application No. 60/328,477, filed on Oct. 11, 2001.

(51) Int. Cl. H04N 7/173; H04N 5/445; H04N 5/45; H04N 7/00; H04N 11/00

(52) U.S. Cl. 725/113; 725/109; 725/112; 348/564; 348/565; 348/552; 725/133

(57) ABSTRACT

A software application, which presents aggregated content including broadcast, Internet, and local media on a single HDTV display screen. For the most part, this information is pulled from existing databases and supplied by means of an entertainment portal, and then synchronized, resized, and displayed on a single HDTV display screen. This allows mixed entertainment content from creators, broadcasters, advertisers, manufactures, websites, and home consumers to be viewed on a single HDTV display screen, thereby creating a single-screen home entertainment experience. In operation, the screen is divided into multiple areas 200, 202 where web content, which can be continuously updated, is displayed at the same time live video is being aired. This can include any and all types of content; such as news, stock quotes, weather forecast, sports scores, on-line shopping, on-line multi-player games, local community information, etc.

### CROSS-REFERENCE TO RELATED INVENTION

This invention is related to the invention disclosed and claimed in co-pending U.S. patent application, filed of even date with the filing date of this Application and bearing Attorney's Docket No. TI-32240, the contents of which are hereby incorporated by reference.

### FIELD OF THE INVENTION

The present invention relates to the presentation of entertainment content and particularly to the presentation of mixed content—from broadcast, Internet, and local media—on a single HDTV display screen.

### BACKGROUND OF THE INVENTION

So much information is now available, with a large portion of this information being delivered by means of television and the Internet, that it is becoming very cumbersome to handle it all. Entertainment and other broadcast information are usually displayed on small display screens and Internet content on personal computer (PC) screens. With so much data, however, multiple screens are often required to make this content available to the user. A typical home may have one or more PC's with a relatively small screen displaying web content and one or more TV's simultaneously displaying video content, with all this providing a multi-screen experience.

As entertainment choices increase to include broadcast, Internet, and local media, it becomes desirable to display all available content on a single HDTV display screen, regardless of which delivery mechanism the information arrives in; e.g., terrestrial broadcast, cable, satellite, Internet, DVD, VCR, etc.

What is needed is a common entertainment application that displays all local and remote entertainment content, coming from various broadcast, Internet, and local media sources, on a single high-resolution display screen, thereby resulting in a single-screen experience. The mixed entertainment application of the present invention meets this need by mixing, resizing, synchronizing, and displaying the various content sources on a single large display screen. This is made possible by the high definition televisions(HDTV), having at least 1280×720 pixel resolution, which are now available.

### SUMMARY OF THE INVENTION

As entertainment choices increase to include broadcast, Internet, and local media, it becomes desirable to display all available content on a single HDTV display screen, regardless of the content type. For the most part, information can be pulled from existing databases and supplied by means of an entertainment portal, and the mixed entertainment application of the current invention will allow this content to be synchronized and displayed on a single HDTV display screen. The objective of the mixed entertainment application is to display content from creators, broadcasters, advertisers, manufacturers, websites, and home consumers on a single HDTV display screen, thereby creating a single-screen home entertainment experience.

In the present invention, the application divides the display screen into multiple areas where video and web content are presented. Web content from a traditional web page can be synchronized and presented on the same screen as the video; with the web content being updated at the same time live video is being aired. This can include any and all types of content; such as news, stock quotes, weather forecast, sports scores, on-line shopping, on-line multi-player games, local community information, etc.

The home entertainment user will not be particularly concerned about where the content originates or where it resides, but that it is easily accessible and presentable on a single HDTV display screen, providing a single-screen entertainment experience.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is an example showing the full-screen video mode of operation for the mixed entertainment application of the present invention.

FIG. 2 is an example of the split-screen mode of operation for the present invention, showing updated web content on the left side and live video on the right side.

FIG. 3 is an example showing the full-screen web mode of operation for the present invention.

FIG. 4 is an example showing the full-screen video mode for the present invention, with a superimposed streaming data ticker across the bottom of the screen.

FIG. 5 is an example showing the full-screen web mode for the present invention, with a superimposed streaming data ticker across the bottom of the screen.

FIG. 6 is a general flow chart for the mixed entertainment application of the present invention.

FIG. 7 is an example of an operation flow chart for the mixed entertainment application of the present invention.

### DETAILED DESCRIPTION OF THE PREFERRED EMBODIMENTS

The present invention discloses a software application that presents aggregated content including broadcast, Internet, and local media on a single HDTV display screen. For the most part, this information is pulled from existing databases and supplied by means of an entertainment portal, and then mixed, synchronized, resized, and displayed on a single HDTV display screen. This allows mixed entertainment content from creators, broadcasters, advertisers, manufacturers, websites, and home consumers to be viewed on a single HDTV display screen, thereby creating a single-screen home entertainment experience.

In the present invention, the application divides the display screen into multiple areas where video and web content are presented. Web content from a traditional web page can be synchronized and presented along side the live video, with the web content being continuously updated as the video is aired. This can include any and all types of content; such as news, stock quotes, weather forecast, sports scores, on-line shopping, on-line multi-player games, local community information, etc. The home entertainment user will not be particularly concerned about where the content originates or where it resides, but that it is easily accessible and presentable on a single HDTV display screen, thereby providing a single-screen entertainment experience.

The mixed entertainment application of the present application provides the capability for the viewer to dynamically resize the proportions of video vs. web content on the screen, so that the viewer can control the size of each displayed element. The application allows for full-screen video, full-screen web, split-screen video and web, any of the above with streaming data superimposed on the screen, or other combinations of the above to be viewed on the single large screen.

The video can be analog TV signals, digital TV signals, HDTV, DVD, VCR, or other signals of varying formats. The web content is provided and presented via an industry standard web browser, thereby ensuring support for all past and future plug-ins and enhancements.

FIG. 1 is an example showing the full-screen video 100 mode of operation for the mixed entertainment application of the present invention. In this mode, a high-resolution version of live or recorded video is presented on the large display screen. This provides a typical TV picture, but presented on a large display screen with high-resolution of at least 1280×720 pixels.

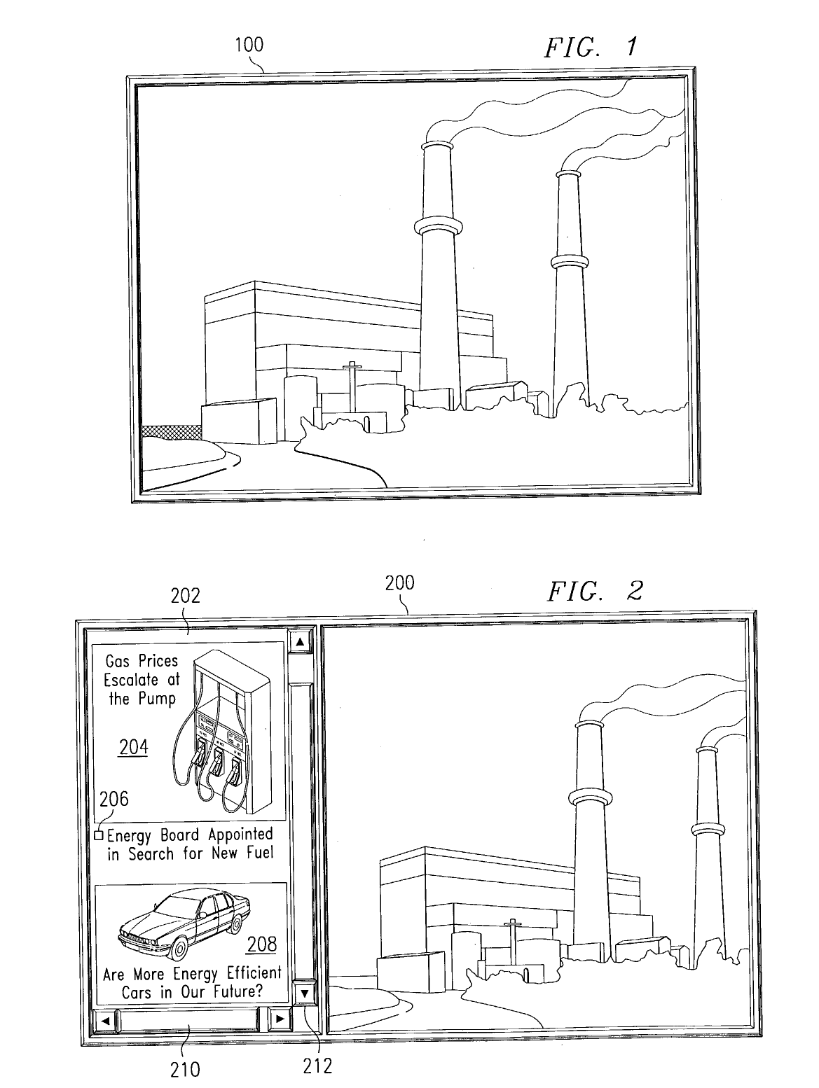

Because the display screen has high-resolution, it can be split into multiple portions to present video content 200 in one portion of the screen and web content 202 over other portions of the screen, as shown in FIG. 2. This example shows web content 204, 206, 208 that relates to the subject of the video, but it could be web content of any subject. Familiar scrolling windows 210, 212 with scrolling buttons are opened in this mode for moving around within the web window in the horizontal and vertical directions, respectively. The user has control of the screen and can dynamically resize the proportions of the video vs. web content to his/her liking. The user can adjust the size of each displayed element in order to provide lots of web content with a small video picture, a large video picture with a small web window, full-screen video, full-screen web, or combinations of these formats. An important aspect of this mode is that there are now multiple sources of web content that are synchronized with particular video programs, such as ABC's “Who Wants To Be A Millionaire.” In this mode the video program and web page are presented on the same screen, with the web content being updated at the same time the video is being aired. This allows the user of the application to “play along” with current broadcast programming, on a single screen.

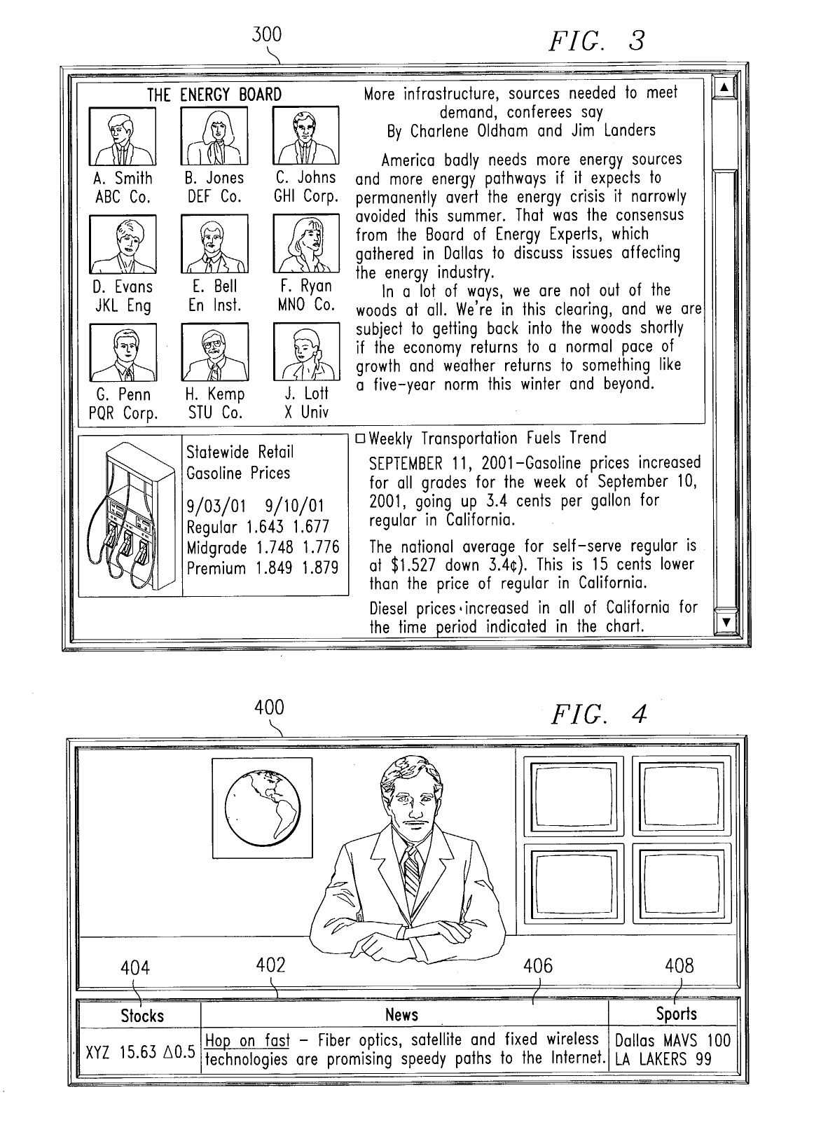

FIG. 3 is an example showing the full-screen web 300 mode of operation for the present invention. This view is comparable to the content that is normally seen on a much smaller PC screen connected to the Internet. Due to the high-resolution and large-size of the display screen, however, the content is easily viewable from the comfort of a couch or chair across the room. The web content is not scaled up in order to make it readable as it is on several web-appliances that display on standard resolution televisions today. By taking advantage of the high resolution inherent in HDTV, the entire web page is displayed as designed and intended by the web content creator.

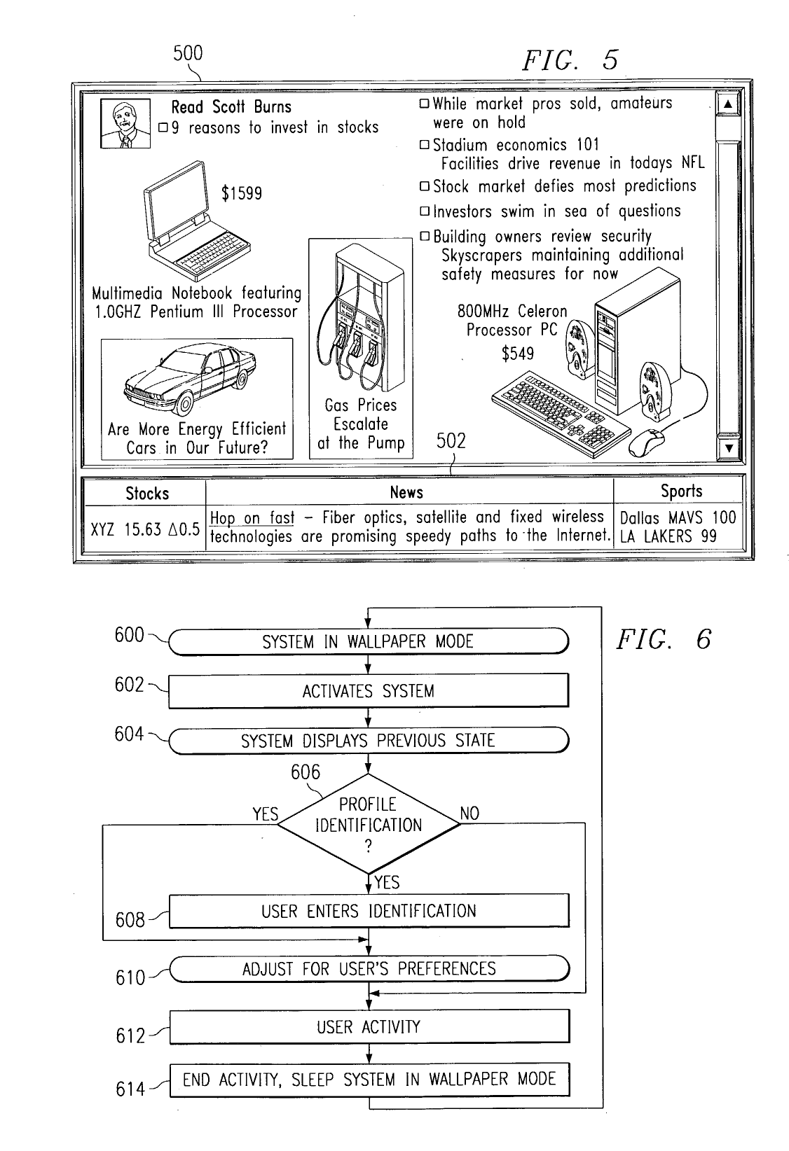

FIG. 4 is another example showing the full-screen video 400 mode of operation with superimposed streaming data ticker 402 across the bottom of the screen. This ticker could be located anywhere on the screen and can contain any available web data. In this example, the stock quotes 404 change every few seconds showing the latest values for selected or all stocks. The news 406 changes at an independent rate, which may or may not be different from the rate at which the stock quotes 404 are updated. Likewise, the sports 408 changes to give the latest scores for selected or all teams. This ticker, which is constantly being updated and presented simultaneously with the live video, can contain any available information.

FIG. 5 is an example showing the full-screen web 500 mode for the present invention, with a superimposed streaming data ticker 502 running across the bottom of the screen. This mode, where most of the screen is dedicated to web content with a small amount of streaming data, is just opposite from that of FIG. 4, where most of the screen is dedicated to video with a small amount of web content. The streaming data ticker 502 could contain any available information, such as sports scores, headline news, weather forecast and alerts, etc.

The mixed mode aspects of the present invention open up a whole arena of multi-tasking features. This present invention will enable a user to access the content at any time and in any state of the system. Examples of the multi-tasking features include:

(1) Headline News: streaming news brings the user headlines as they happen. For example, getting the election returns while watching a movie with the family.

(2) Stock Ticker: home entertainment turns into the home office with streaming stock quotes scrolling across the HDTV screen while watching noon news or a favorite morning show.

(3) Sport Scores: get streaming scores for all the day's sporting events while watching other TV programs or working on another website.

(4) Weather: current conditions, weekly forecasts, and instant storm warnings are available anytime without having to wait until the five o'clock news.

(5) Instant Messaging: the user can chat with a friend or business associate while carrying out other activities on the system.

(6) Multi-player Games: an extended offering of interactive games and streaming applications. Favorite Web games will be easily available to the user at any time. The user can play these games with family members in the living room, friends across the street, or grandmother in Texas. These games can be played simultaneously while watching TV.

FIG. 6 is a general flow chart showing how a user activates and operates an HDTV system built around the mixed entertainment application of the present invention. This application provides security and parental guidance capability to assure proper use of the system. The operational sequence of events for a typical user is as follows:

(1) The system idles in the Wallpaper or blank screen mode 600.

(2) The system is turned on (activated) 602 by the user with a remote control and the screen goes to the last used state 604 (function and channel on HDTV full screen mode).

(3) Opportunity comes up for profile ID 606. If feature is activated, User identifies himself/herself to the system 608. This could be an ID code entered on the remote control, a personalized remote command, voice command, or other means.

(4) The system adjusts for user's preferences 610 and goes to preference screen view.

(5) If profile ID feature is not activated, system goes directly to a default preference screen view.

(6) The user completes his/her entertainment activities 612.

(7) When the session is complete, the user turns off 614 all activities and returns HDTV screen to wallpaper or blank screen mode 600.

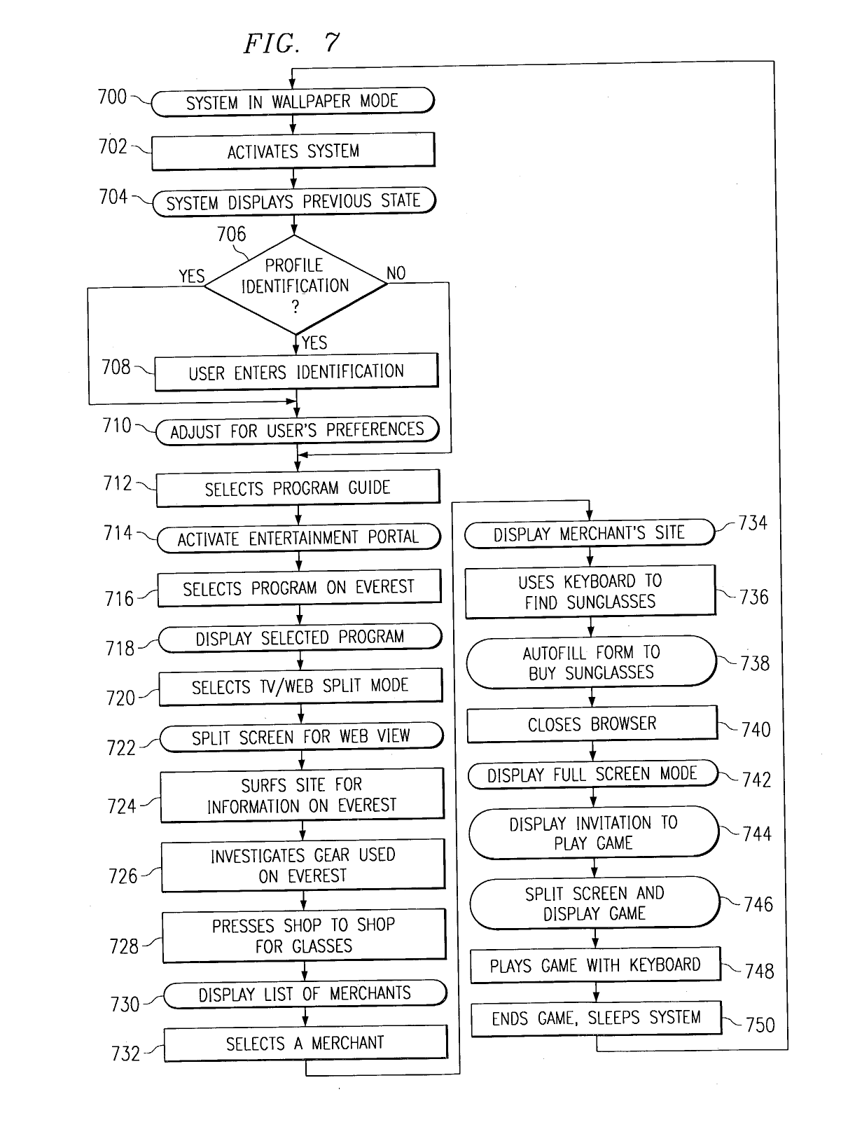

FIG. 7 shows a more detailed example for a user (perhaps an adult) of an HDTV system containing the mixed entertainment application of the present invention. The sequence of events for this user is as follows:

(1) The system idles in the Wallpaper or blank screen mode 700.

(2) The system is turned on (activated) 702 by the user with a remote control and the screen goes to the last used state 704(function and channel on HDTV full screen mode).

(3) Opportunity comes up for profile ID 706. If feature is activated, User identifies himself/herself to the system 708. This could be an ID code entered on the remote control, a personalized remote command, voice command, or other means.

(4) The system adjusts for user's preferences 710 and goes to preference screen view.

(5) If profile ID feature is not activated, system goes directly to a default preference screen view.

(6) The user selects Program Guide 712.

(7) The entertainment portal is activated and the program guide is selected 714.

(8) The user finds and selects HDTV-enhanced Everest climb 716 from the entertainment portal.

(9) Control is returned to the application and the HDTV screen shows full screen video of the Everest climb 718.

(10) The user selects TV/Web Split screen mode 720 and screen splits showing Web view 722.

(11) The user then surfs the site for associated information on Everest 724.

(12) The user investigates gear used for mountain climbing 726.

(13) The user selects an online shopping option from the web page to look for sunglasses used on climb 728.

(14) A list of merchants is displayed on the web portion of the screen 730.

(15) The user chooses merchant associated with Gargoyle Sunglasses 732.

(16) The Gargoyle Sunglasses website is displayed 734 on the web portion of the screen.

(17) The user uses keyboard/mouse to search site for a particular pair of sunglasses 736.

(18) The user fills out the form to purchase sunglasses 738.

(19) The user closes the browser 740 and switches back to HDTV full-screen mode 742 to pick up the action.

(20) The user sees an on-screen URL invitation 744 to play a trivia game.

(21) The application is set to split-screen mode, and the URL is entered 746.

(22) The user plays the game using the keyboard 748, while watching a TV show.

(23) The user ends the game, completes the session 750, and puts the portal to sleep, and allows the system to return to the wallpaper or blank screen mode 700.

While this invention has been described in the context of a preferred embodiment, it will be apparent to those skilled in the art that the present invention may be modified in numerous ways and may assume embodiments other than that specifically set out and described above. Accordingly, it is intended by the appended claims to cover all modifications of the invention that fall within the true spirit and scope of the invention.

What is claimed is:

1. A method for presenting multiple forms of entertainment content, said method comprised of:
mixing content from the group of sources consisting of broadcast TV, local media, and the Internet; and
presenting said mixed content on a single HDTV split-screen display, wherein each web and video content element is capable of being dynamically resized and positioned on said display screen by the user.

2. The method of claim 1, said presenting comprising:
using a single common application to present all forms of said content.

3. The method of claim 1, comprising:
receiving said content from at least one source selected from the group consisting of: terrestrial broadcast, cable, satellite, Internet, DVD, and VCR.

4. The method of claim 1, comprising:
receiving said content originating from both local and remote sources.

5. The method of claim 1, wherein said HDTV screen is simultaneously shared among content from at least two available sources.

6. The method of claim 1, said presenting comprising:
splitting said screen to display video content in one portion and web content in another portion of said screen.

7. The method of claim 1, said presenting comprising:
presenting full-screen video content.

8. The method of claim 1, said presenting comprising:
presenting full-screen web content.

9. The method of claim 1, said presenting comprising:
displaying synchronized web content, said web content being continuously updated on said screen while a video program is simultaneously aired.

10. The method of claim 1, comprising:
superimposing a streaming data ticker across said display screen.

11. The method of claim 1, comprising:
superimposing a streaming data ticker across said display screen over both video and web content.

12. The method of claim 1, comprising:
receiving said video from a source selected from the group consisting of:
analog TV signals, digital TV signals, HDTV, DVD, and VCR; and
presenting said web content using a web browser.

13. The method of claim 1, said presenting allowing said user to access any available content at any time, from any state of the system.

14. A display system for mixing entertainment content, said display system comprising
a display device;
a video receiver receiving at least one video content element;
a web browser receiving at least one web content element;
a controller receiving image information from said video receiver and said web browser, said controller mixing said image information and processing said image information to allow simultaneous display on said display device wherein each said web and said video content element is capable of being dynamically resized and positioned on said display screen by the user, said controller further providing said processed image information to said display device.

15. The display system of claim 14, said video receiver selecting at least one content element from the group consisting of terrestrial broadcast, cable, satellite, Internet, DVD, and VCR.

16. The display system of claim 14, wherein said content originates from both local and remote sources.

17. The display system of claim 14, wherein said display screen is simultaneously shared among content from all available sources.

18. The display system of claim 14, wherein full-screen video content is displayed.

19. The display system of claim 14, wherein full-screen web content is displayed.

20. The display system of claim 14, wherein said content consists of web content synchronized to a video program, said web content being continuously updated on said screen while said video program is simultaneously aired.

21. The display system of claim 14, wherein a streaming data ticker is superimposed across said display screen.

22. The display system of claim 14, said video receiver receiving said video content element from at least one source selected from the group consisting of: analog TV signals, digital TV signals, HDTV, DVD, and VCR.

23. The display system of claim 14, said web browser being an industry standard web browser.

24. The display system of claim 14, said controller allowing display of any available content at anytime from system state.

25. The display system of claim 14, said controller operable to provide a streaming data ticker superimposed over both said video content and said web content.
